(19) United States
(12) Patent Application Publication
(10) Pub. No.: US 2022/0266374 A1
(43) Pub. Date: Aug. 25, 2022

(54) Mounting attachment, use and method of manufacture

(71) Applicant: Orbitalservice GmbH, Heimbuchenthal (DE)

(72) Inventor: Dirk KUNZE, Mespelbrunn (DE)

(73) Assignee: Orbitalservice GmbH, Heimbuchenthal (DE)

(21) Appl. No.: 17/633,298

(22) PCT Filed: Feb. 16, 2021
(86) PCT No.: PCT/DE2021/000030

§ 371 Date: Feb. 7, 2022

(30) Foreign Application Priority Data
Aug. 13, 2020 (DE) 10 2020 004 936.2

(51) Int. Cl. B23K 9/32; B23K 9/028; F16L 19/02

(52) U.S. Cl. CPC B23K 9/326; B23K 9/0282; F16L 19/0218

(57) ABSTRACT

A mounting attachment with a connection area for a gas line includes a first cylindrical fastening medium and a second cylindrical fastening medium, which are in particular screwable into each other. The first fastening medium and/or the second fastening medium are prepared in a 3D-plastic printing process. A pipe to be welded is inserted into the first cylindrical fastening medium by means of an essentially central lead trough in the first cylindrical fastening medium, with a cylindrical area of insertion for the pipe to be welded in the second fastening medium. The area of application includes an attachment ring area and a connection area for a gas feed hole for feeding forming gas to a gas-use point by means of a forming gas pipe in the pipe to be welded. The pipe used is sealed against the cylindrical fastening media by one or more flexible seals.

### TECHNICAL FIELD

The disclosure concerns a mounting attachment with a connection area for a forming gas line, its use, its manufacture.

### BACKGROUND

It is well-known that for forming gas pipes in the welding process of pipelines mounting attachments are used which are partly not completely sealed due to prefabrication or have to be supplied with a large number of different sizes, which then in the specific case of application seldom have complete security against lateral ingress of room air etc.

### SUMMARY

The present disclosure provides a safe and reliable fastener which avoids the disadvantages of the state of the art.

A mounting attachment with a connection area for a forming gas line comprises a first cylindrical fastening medium and a second cylindrical fastening medium, which are to be attached to each other in a removable way, in particular screwable into each other, whereas the first fastening medium and/or the second fastening medium are adapted prepared in a 3D-plastic printing process, in such a way that a pipe to be welded is to be inserted into the first cylindrical fastening medium by means of an essentially central lead trough in the first cylindrical fastening medium, with a cylindrical area of insertion for the pipe to be welded in the second fastening medium, where the area of application includes an attachment ring area and a connection area for a gas feed hole for feeding forming gas to a gas-use point by means of a forming gas pipe in the pipe to be welded, the pipe used being sealed against the cylindrical fastening media by one or more flexible seals, in particular sealing rings, specially adapted manufactured in a 3D plastic printing process.

The present invention makes it possible to provide a precisely adapted, lightweight and yet securely sealing mounting attachment on pipelines welded under forming gas protection, in particular argon, nitrogen and their mixture with hydrogen components, which is both sustainable and material-saving thin-walled, as it is advantageous to can be made essentially of a plastic material. The device provides a simple and safe fastening, in particular by means of bolting, whereby the seals manufactured in an integrated way are tightened tightly to prevent gas leakage. This is particularly advantageous for a TIG manual or TIG orbital welding process.

The disclosure provides a reliable, compact mounting attachment, which does not require a large number of different diameters in stock, as mounting attachments manufactured by the 3D plastic printing process can be quickly and precisely adapted to the pipe to be welded. It is advantageous to integrate the entire device, including in particular both mounting attachments, the seals and the swirling nozzles in the 3D printing process and precisely designed to prevent leakage. The exemplary use of a gas turbulence nozzle integrated in the 3D plastic printing process also prevents different pollutants, such as manganese oxides, from depositing on an interior wall inside, i. e. in the immediate vicinity of a weld seam. This is particularly advantageous in the field of UHP applications.

It is advantageous that the seals, in particular a first seal and a second seal, are inserted in the second cylindrical fastening medium.

It is advantageous that the seals are constructed as elastic hollow rings which are custom-made in a 3D plastic printing process and which are deformable by fastening, in particular by screwing the fasteners to each other, to form a sealing contact on the pipe.

It is advantageous that the seals are constructed as elastic hollow rings which are custom-made in a 3D plastic printing process and which are deformable by fastening, in particular by screwing the fasteners to each other, to form a sealing contact on the pipe. The hollow rings can deform by several mm during pressing and are therefore optimally adapted around the pipe. The hollow rings can be produced advantageously completely in a 3D plastic printing process, especially in the FDM process. Sustainable disposal is also improved, particularly due to the material unit.

It is advantageous that seals, in particular elastic hollow rings, are separated by one or more intermediate elements to form a functional unit suitable for use in the second fastening medium, whereby, when fastening, in particular, screwing the fastening media together, the seals, in particular hollow rings, are to be pressed in a sealing manner against which the intermediate element(s) and against the inserted pipe. The sealing rings are easily movable due to the intermediate elements, so that no distortion and subsequent leakage occur when screwing.

It is advantageous if into the second fastening medium at the gas feed hole for feeding forming gas into the pipe a forming gas nozzle is placed extending the forming gas line, which in particular made possible a vortex-shaped diversion of the incoming forming gas and which have to be adapted in a 3D plastic printing process, in particular interchangeable, depending on the need for turbulence. The gas swirling nozzle can be used in particular on the inside of a Schott-Plug-Nipple connection for forming gas line. The gas swirling nozzle delivers a gas flow that runs tightly along the walls of the pipe, reliably preventing the formation of various manganese oxides on the inside wall of the pipe, in the immediate vicinity of a weld seam. Especially in the field of UHP applications this is not intended. For example, various connection options of the forming gas line, in particular connectors, can be provided.

It is advantageous if a cylinder width of one end of the first mounting device corresponds to a standardized pipe thickness and/or the forming gas line is standardized to the second mounting device to a 3D printed thread.

It is advantageous if the fasteners are made of one piece each, especially together with the seals.

It is advantageous if the first mounting material and/or a second mounting material is adapted to an FDM printing process.

It is advantageous to use of a device as claimed, with a first and second mounting device for mounting on a pipe with a forming gas line as a protective gas line during hot processing of metals, in particular soldering and/or welding and/or rolling and/or pressing and/or annealing, in particular TIG-H and TIG orbital welding, where the brackets and/or the seals are formed in a 3D plastic printing process that can be adapted to the pipe.

A method for manufacturing a device as claimed is provided, whereby a mounting attachment with a connection area for a forming gas line is attached to a pipe and a first cylindrical fastening medium and a second fastening medium are attached to each other in a removable way, in particular interlocking where the first cylindrical fastening medium and the second fastening medium are fitted in a 3D plastic printing process in such a way that the pipe to be welded is held with a cylindrical area of insertion by a essentially centralized lead trough in the first fastening medium. for the pipe to be welded in the second fastening medium, where the area of insertion has an attachment ring area and a connection area for a gas through hole for feeding forming gas to a gas use point through a forming gas pipe in the pipe to be welded, where the pipe used is sealed to the cylindrical fastening media by seals, in particular hollow rings, which are manufactured custom-made in a 3D plastic printing process and which, after assembly, keeps the used pipe sealed.

Further features and advantages of the invention are to be found in the claims and the description below, which gives details of embodiments of the subject-matter of the invention in conjunction with the drawings.

### BRIEF DESCRIPTION OF THE DRAWINGS

FIG. 1 shows a device in a perspective sectional view.

FIG. 2 shows a device in the external view.

### DETAILED DESCRIPTION

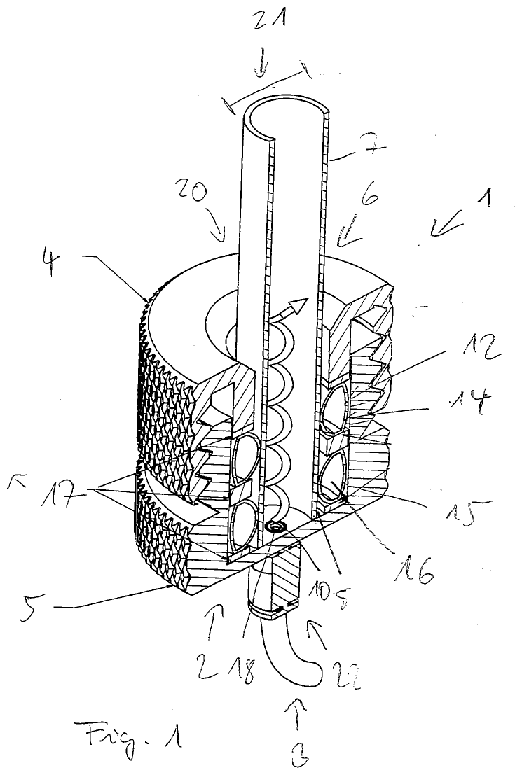

FIG. 1 shows a device according to the invention in perspective, where a mounting attachment 1 with a connection area 2 for forming gas line 3 is arranged to a pipe 7, comprising a first cylindrical fastening medium 4 and a second cylindrical fastening medium 5, which can be attached to each other are inter alia screwable with each other, the first fastener 4 and/or a second fastening medium 5 being so adapted in a 3D plastic printing process that a pipe 7 to be welded and inserted with a cylindrical application area 8 is to be held by means of an essentially centralized application 6 in the first fastening medium 4 for pipe 7 to be welded in the second fastening medium 5, where the area of application 8 has a connecting ring area 9 and a connection area 2 for a gas through hole 10 for feeding forming gas to a gas use point through a forming gas line 3 in the pipe to be welded 7, where the pipe used 7 is compared to the z Cylindrical fastening media 4,5 are sealed by one or more seals 12, in particular sealing rings 13, which are custom-made in a 3D plastic printing process, whereby seals 12, in particular a first seal 14 and a second seal 15, are used in the first 4 and/or second cylindrical fastening media 5.

Seals 12, e. g. elastic hollow rings 16, are separated by several intermediate elements 17, so that a functional unit is formed which can be used in the second fastening medium 5, whereby, when fastening, in particular screwing the fastening media 4,5 to each other, the seals, in particular hollow rings 16, against the intermediate element(s) 17 and against the rotating device used piping are to be pressed sealing.

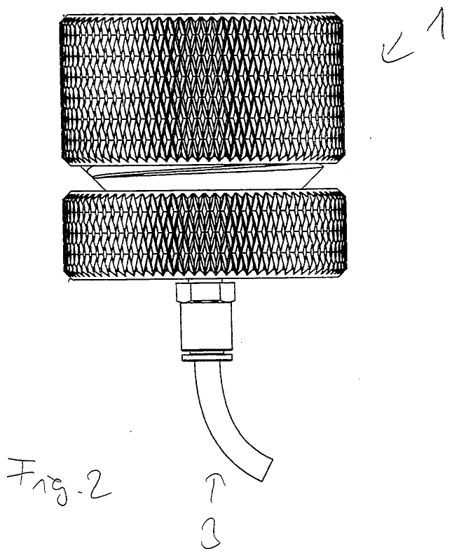

FIG. 2 shows a device according to the invention in an external view. In particular, it demonstrates how easy and safe the connection of the mounting attachment 1 is possible, whereby an unrepresented pipe is held by a sealing function unit.

### LIST OF REFRENCE SIGNS

1 mounting attachment

2 connection area

3 forming gas line

4 first cylindrical fastening medium

5 second cylindrical fastening medium

6 lead trough

7 pipe

8 area of insertion

9 attachment ring area

10 gas feed hole

12 sealing

13 sealing ring

14 first seal

15 second seal

16 hollow ring

17 intermediate element

18 forming gas nozzle

20 insert end

21 thickness of pipe

22 thread

1.-10. (canceled)

11. A mounting attachment (1) with a connection area (2) for a forming gas line (3),
comprising
a first cylindrical fastening medium (4) and
a second cylindrical fastening medium (5), which are screwable into each other,
wherein the first fastening medium (4) and/or the second fastening medium (5) are adapted prepared in a 3D-plastic printing process, in such a way that a pipe (7) to be welded is to be inserted into the first cylindrical fastening medium (4) by an essentially central lead trough (6) in the first cylindrical fastening medium (4), with a cylindrical area of insertion (8) for the pipe (7) to be welded in the second fastening medium (5),
where an area of application (8) includes an attachment ring area (9) and a connection area (2) for a gas feed hole (10) for feeding forming gas to a gas-use point by means of a forming gas pipe (3) in the pipe to be welded (7),
the pipe (7) being sealed against the first fastening medium (4) and the second fastening medium (5) by one or more flexible seals (12) specially adapted manufactured in a 3D plastic printing process.

12. The mounting attachment (1) according to claim 11,
wherein the one or more flexible seals (12) comprise
a first seal (14) and
a second seal (15)
that are inserted in the second cylindrical fastening medium (5).

13. The mounting attachment (1) according to claim 11,
wherein the one or more flexible seals are constructed as elastic hollow rings (16) which are custom-made in a 3D plastic printing process and which are deformable by screwing the first fastening medium (4) and the second fastening medium (5) to each other, to form a sealing contact on the pipe (7).

14. The mounting attachment (1) according to claim 11,
wherein the one or more flexible seals (12) are elastic hollow rings (16) which are separated by one or more intermediate elements (17) to form a functional unit suitable for use in the second fastening medium (5),
wherein, when screwing the first fastening medium (4) and the second fastening medium (5) together, the elastic hollow rings (16) are pressed in a sealing manner against the one or more intermediate elements (17) and against the inserted pipe.

15. The mounting attachment (1) according to claim 11,
wherein into the second fastening medium (5) at the gas feed hole (10) for feeding forming gas into the pipe (7) a forming gas nozzle (18) is placed extending the forming gas line (3), which causes a vortex-shaped diversion of the incoming forming gas.

16. The mounting attachment (1) according to claim 11,
wherein a circumference of a cylinder width of an insert end (20) of the first fastener (4) is equal to a standardized pipe thickness (21) and/or the forming gas line (3) being standardized to the second fastening medium (5) being screwed to a 3D printed thread (22).

17. The mounting attachment (1) according to claim 11,
wherein the first fastening medium (4) and the second fastening medium (5) are formed in one piece together with the one or more flexible seals.

18. The mounting attachment (1) according to claim 11,
wherein the first fastening medium (4) and/or a second fastening medium (5) are adapted to an FDM printing process.

19. A method, comprising:
providing the mounting attachment (1) according to claim 11;
mounting the pipe (7) with the forming gas line (3) as a protective gas line in hot-processing of metals, namely soldering and/or welding and/or rolling and/or pressing and/or annealing, TIG manual and TIG orbital welding,
wherein the first fastening medium (4) and the second fastening medium (5) and/or the one or more flexible seals are formed in a 3D printing process that can be adapted to the pipe.

20. A method for manufacturing a mounting attachment (1), comprising:
attaching a mounting attachment (1) with a connection area (2) for a forming gas line (3) to a pipe and
attaching a first cylindrical fastening medium (4) and a second fastening medium (5) to each other in a removable way,
wherein the first cylindrical fastening medium (4) and the second fastening medium (5) are fitted in a 3D plastic printing process in such a way that the pipe (7) to be welded is held with a cylindrical area of insertion (8) by an essentially centralized lead trough (6) in the first fastening medium (4). for the pipe to be welded (7) in the second fastening medium (5),
wherein the area of insertion (8) has an attachment ring area (9) and a connection area (2) for a gas through hole (10) for feeding forming gas to a gas use point through a forming gas pipe (3) in the pipe (7) to be welded,
wherein the pipe (7) is sealed to the first fastening medium (4) and the second fastening medium (5) by seals (12), which are manufactured custom-made in a 3D plastic printing process and which, after assembly, keep the pipe sealed.
